(19) United States
(12) Patent Application Publication
(10) Pub. No.: US 2010/0084855 A1
(43) Pub. Date: Apr. 8, 2010

(54) ECONOMY LIQUIDTIGHT FITTING

(75) Inventor: Thomas Evans, Cordova, TN (US)

Correspondence Address: HOFFMANN & BARON, LLP, 6900 JERICHO TURNPIKE, SYOSSET, NY, 11791, US

(73) Assignee: Thomas & Betts International, Inc., Wilmington, DE (US)

(21) Appl. No.: 12/575,022

(22) Filed: Oct. 7, 2009

Related U.S. Application Data
(60) Provisional application No. 61/195,423, filed on Oct. 7, 2008.

(51) Int. Cl. F16L 55/00

(52) U.S. Cl. 285/89

(57) ABSTRACT

A fitting for a liquidtight conduit that includes a compression ring, a ground cone and a locknut. The compression ring has a first end that is adapted to receive a liquidtight conduit and a second end that has a perimetrical lip that extends radially from the exterior surface and a collar that extends from the second end. The locknut is ring-shaped and has an aperture in the middle. The ground cone has a flanged end and a plain end. The locknut passes over the plain end and is attached to the back side of the flanged end. When the fitting is installed, the plain end of the ground cone passes through an aperture in a wall and the second end of the compression ring. A plurality of threads on the exterior surface of the ground cone engages the interior surface of the liquidtight conduit in the compression ring and, when the ground cone is rotated, the threads move the conduit towards wall.

This application claims priority from provisional application Ser. No. 61/195,423, filed on Oct. 7, 2008, which is incorporated herein in its entirety.

### FIELD OF THE INVENTION

The present invention is a fitting for quickly connecting and disconnecting liquidtight conduit. In particular, the present invention relates to an electrical fitting that is used to connect liquidtight conduit to the wall of an enclosure.

### BACKGROUND OF INVENTION

Liquidtight flexible conduit is used in many applications, including industrial applications, to protect electric current-carrying wires. The fittings presently being used to connect liquidtight conduit to enclosures include multiple components and are expensive to manufacture. Accordingly, there is a need for an economical fitting that can be easily installed and provides a reliable liquidtight seal with high conduit pull-out resistance. There is also a need for a fitting for attaching a conduit to an enclosure that can be tightened either by hand or with tools.

### SUMMARY OF THE INVENTION

In accordance with the present invention, a liquidtight fitting is provided that includes a compression ring, a ground cone and a locknut. The compression ring includes a tubular body, a perimetrical lip, a collar and a stop. The tubular body has an interior surface, an exterior surface, an inner diameter, a first end and a second end. The first end is adapted to receive a liquidtight conduit having an interior surface. The perimetrical lip extends radially from the exterior surface near the second end of the tubular body and the collar is connected to and extends from the second end of the body. The collar is ring-shaped and the side of the collar opposite the second end of the tubular body has a distal circumferential edge. Preferably, the collar has an inner diameter that is less than the inner diameter of the tubular body of the compression ring. The stop is located on the interior surface of the body and is adapted to prevent the conduit from passing through the second end of the tubular body. Preferably, the stop is formed at the point where the collar connects to the second end of the tubular body. The compression ring can also include an O-ring extending radially inwardly from the interior surface and intermediate the first and second ends of the tubular body. The O-ring has an inner diameter that is less than the inner diameter of the tubular body and sealably receives the liquidtight conduit inserted into the first end of the compression ring.

The ground cone includes a cylindrical body, a plain end and a flanged end. The cylindrical body has an axial bore, an inner surface, an outer surface, an outer diameter and a plurality of threads on the outer surface. The plain end is adapted to be inserted into the second end of the compression ring and the threads are adapted to engage the interior surface of the liquidtight conduit that is inserted into the first end of the compression ring. When the ground cone is rotated, the threads move the conduit towards the second end of the compression ring in a screw-like manner. The flanged end of the ground cone has a front flange surface opposite the plain end and an opposing back flange surface.

The locknut includes a substantially flat ring-shaped body having a first side, a second side, an inner diameter and an outer diameter. Preferably, the inner diameter of the locknut is greater than the outer diameter of the cylindrical body of the ground cone. The first end of the ground cone is inserted through the locknut and the first side of the locknut is attached to the back flange surface of the ground cone. The ring shaped body of the locknut has an inner circumferential edge and an outer circumferential edge. The outer circumferential edge can have a plurality of flat surfaces that are adapted for engagement by a wrench. Preferably, the inner circumferential edge is tapered so that the diameter of the inner circumferential edge on the first side is less than the diameter of the inner circumferential edge on the second side of the locknut. The second side of the locknut can have a plurality of grooves extending between the inner and outer circumferential edges. These grooves engage the flat surface of a wall or enclosure when the liquidtight fitting is installed.

To install the fitting, the liquidtight conduit is inserted into the first end of the compression ring and the plain end of the ground cone is inserted into an opening in a flat surface, typically a wall, and then into the second end of the compression ring. The ground cone and the locknut are rotated so that the threads on the outer surface of the ground cone engage the interior surface of the liquidtight conduit and move the conduit towards the flanged end of the ground cone. At the same time, the distal circumferential edge of the collar is sealably received by the inner circumferential edge of the locknut and the perimetrical lip sealably contacts the flat surface.

In a preferred embodiment, the ground cone and the locknut are formed as a unitary structure. This combination of the ground cone and locknut is also referred to herein as the ground cone/locknut assembly. The compression ring is preferably made from a semi-rigid material, such as an elastomeric material. The material must be rigid enough to maintain its shape and pliant enough so that it forms a seal around the liquidtight conduit and against the wall when the fitting is tightened. As used herein, the term “elastomeric material” refers to a thermoplastic or thermoset material that can stretch and then return to its original shape without permanent deformation, such as rubber or certain types of plastic materials. The ground cone and locknut can be made from either a metal material or a combination of metal and plastic.

### BRIEF DESCRIPTION OF THE FIGURES

The preferred embodiments of the liquidtight fitting of the present invention, as well as other objects, features and advantages of this invention, will be apparent from the accompanying drawings wherein:

FIG. 1 is a side, sectional view of the liquidtight fitting mounted to the wall of an enclosure.

FIG. 2 is a side, sectional view of the ground cone/locknut assembly of the liquidtight fitting shown in FIG. 1.

FIG. 3 is a side, sectional view of the compression ring of the liquidtight fitting shown in FIG. 1.

FIG. 4 is an end view of the flanged surface of the ground cone shown in FIG. 2.

FIG. 5 is a side view of the locknut shown in FIG. 2.

FIG. 6 is an end view of the locknut shown in FIG. 2.

### DETAILED DESCRIPTION OF THE INVENTION

The present invention relates to a fitting that is used to connect insulated cables or conduits (also referred to herein as “liquidtight conduit”) to a flat surface such as a wall of an enclosure. The fittings are designed to maintain the liquidtight integrity of the conduit at the point where the conduit is connected to the enclosure. Similar fittings are disclosed in U.S. Pat. No. 5,072,072 to Bawa et al. and U.S. Pat. No. 7,183,486 to Pyron et al., both of which are incorporated herein in their entirety.

The liquidtight fitting of the present invention includes a locknut that is attached to a ground cone and can be formed as a unitary structure. The locknut/ground cone assembly is inserted through an opening in a substantially flat surface (also referred to herein interchangeably as “a wall” or “the wall of an enclosure”) from the inside so that the stop surface (i.e., the flat surface of the locknut) contacts the surface of the wall around the opening on the inside of the enclosure and prevents the locknut/ground cone assembly from passing through to the outside. To accomplish this, the diameter of the aperture of the locknut is at least about the same as the diameter of the opening in the wall and the outer diameter of the ring-shaped locknut is greater than the diameter of the opening in the wall. The ground cone portion operates in the normal fashion (i.e., it electrically contacts the liquidtight conduit to ground the conduit to the inside of the enclosure) and is threaded into the inside of an insulated cable or conduit. On the outside of the enclosure, one end of the compression ring is fitted onto the end of a liquidtight conduit (a stop inside the compression ring limits the insertion distance). The second end of the compression ring is then pushed onto the ground cone so that the ground cone is positioned inside the liquidtight conduit. As the ground cone is rotated, it draws the liquidtight conduit towards the wall of the enclosure, thereby causing the second end of the compression ring to abut the enclosure and form a seal around the opening in the wall of the enclosure.

As used herein, the term “liquidtight conduit” refers to different types of flame-resistant, non-metallic tubing with interior surfaces that can be smooth or corrugated. The liquidtight conduit can have integral reinforcement within the conduit wall. However, the use of the term “liquidtight conduit” is not intended to limit the scope of the invention and the fitting can be used with other types of insulated cables and conduits.

The locknut/ground cone assembly is formed by passing a locknut over the plain end of a ground cone and then affixing it to the back surface of the flange on the second end of the ground cone (or, alternatively, forming the two components as an integral unit, i.e., a unitary structure). The locknut/ground cone assembly is inserted into one side of an opening in a wall (generally the interior side of an enclosure) and then into the compression ring as described in more detail below. The opening is sized so that the flat surface of the locknut extends beyond the perimeter of the opening and prevents the locknut/ground cone assembly from being pulled through the opening when the fitting is tightened.

The ground cone has a cylindrical body with an axial bore, an inner surface, an outer surface, an outer diameter and a plurality of rings or threads on the outer surface. The ground cone also has a plain end adapted for insertion into the second end of the compression ring and a flanged end having a front flange surface opposite the plain end and a back flange surface. The threads on the outer surface of the cylindrical body are adapted to engage the interior surface of a liquidtight conduit and, when rotated, draw the conduit and the compression ring towards the flanged end of the ground cone.

The locknut has a substantially flat ring shaped body with an inner diameter and an outer diameter. The inner diameter is greater than the outer diameter of the cylindrical body of the ground cone. The ring-shaped body of the locknut has an inner circumferential edge that is tapered or beveled so that the inner circumferential edge on the first side (i.e., the side that contacts the flanged end of the ground cone when the locknut is attached to the ground cone) has a smaller diameter than the inner circumferential edge on the second side (i.e., the side that contacts the wall of the enclosure) of the locknut. This allows the collar of the compression ring to snugly fit into the annular space between the circumferential edge of the locknut and the ground cone. When the fitting is tightened, the distal circumferential edge of the collar sealably contacts the ground cone and locknut. The second side of the locknut can have a plurality of grooves extending between the inner and outer circumferential edges. These grooves provide a griping surface when the locknut is tightened against the wall of an enclosure.

The cylindrically shaped compression ring has a tubular-shaped body, an axial bore extending between the first and second ends, a first inner diameter, an interior surface and an exterior surface. The first end of the compression ring receives a liquidtight conduit and the second end receives the plain end of the ground cone. The second end of the compression ring has a perimetrical lip extending radially from the exterior surface and a ring-shaped collar extending from the second end. The collar operates as described above and the perimetrical lip sealably contacts the wall of the enclosure when the fitting is tightened during installation.

The end of a liquidtight conduit is inserted in the first end of the compression ring and pushed in until the conduit is prevented from moving any further by a stop on the interior surface of the compression ring near the second end. This stop can be formed by the collar. Preferably, the collar has an inner diameter that is less than the inner diameter of the tubular-shaped body of the compression ring. The point on the inner surface of the compression ring where the inner diameter is reduced is designed so that the liquidtight conduit cannot pass through the second end of the compression fitting.

After the locknut/ground cone assembly is inserted through the opening in a wall, the plain end of the ground cone is inserted into the second end of the compression ring and then into the bore of the conduit. The assembly is rotated to draw the conduit and compression ring toward the wall of the enclosure. This causes the compression ring to ultimately sealably contact the outside surface of the enclosure. A seal is also formed on the inside of the compression ring by an O-ring that extends radially inwardly from the interior surface of the compression ring at a point intermediate the first and second ends. The O-ring is compressible and the inner diameter is designed to snugly engage the liquidtight conduit. When a liquidtight conduit is inserted in the compression ring, the O-ring provides a seal to prevent dust and moisture from entering.

When the fitting is used to attach a liquidtight conduit to a flat surface, such as the wall of an enclosure, the liquidtight conduit is inserted into the first end of the compression ring up to the stop on the inside of the compression ring adjacent the collar. The plain end of the ground cone is inserted into an opening in the flat surface and then into the second end of the compression ring. The ground cone and the locknut are rotated so that the threads on the outer surface of the ground cone engage the interior surface of the liquidtight conduit. This draws the compression ring and liquidtight conduit towards the flat surface until the collar of the compression is snugly contacting the flat surface.

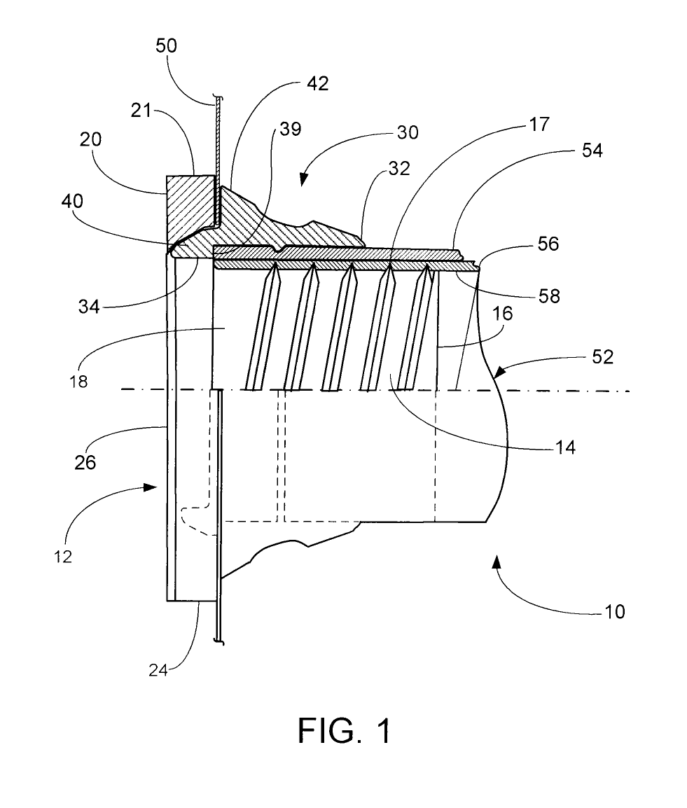

Referring now to the drawings, FIG. 1 shows the liquidtight fitting 10 mounted to the wall 50 of an enclosure and connected to a liquidtight conduit 52. The flanged end 26 of the ground cone 14 is attached to (or formed as part of) the locknut 24 to create the ground cone/locknut assembly 12. Plain end 16 of the ground cone 14 is then inserted through the wall 50 of the enclosure from the inside. A liquidtight conduit 52 having interlocked, inner steel body 56 and an outer jacket 54 is inserted into the first end 32 of the compression ring 30 until it abuts stop 39. The second end 34 of the compression ring 30 is pushed over the plain end 16 of the ground cone 14. The ground cone/locknut assembly 12 is then rotated so that the threads 17 on the exterior surface of the cylindrical body 18 of the ground cone 14 engage the interior wall 58 of the liquidtight conduit 52 to draw the conduit 52 along with the compression ring 30 towards the wall 50. The ground cone/locknut assembly 12 is rotated until the collar 40 on the second end 34 of the compression ring 30 passes through the opening in the wall 50 and the perimetrical lip 42 is flush against the exterior of the wall 50.

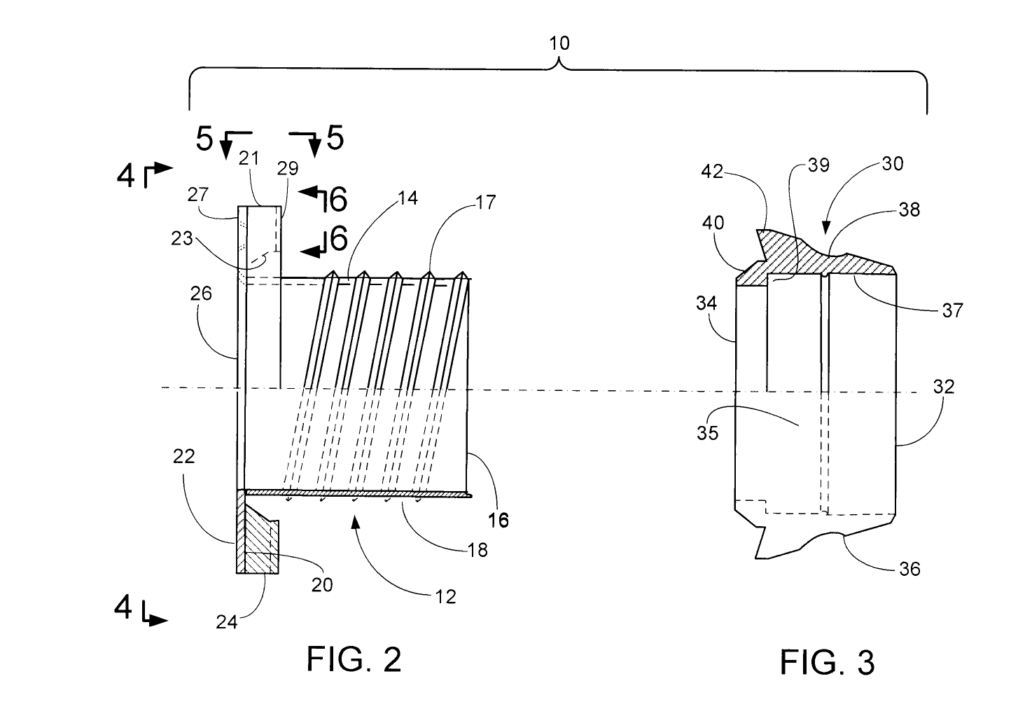

FIG. 2 shows the ground cone/locknut assembly 12 of the liquidtight fitting 10, which is formed when the ground cone 14 is attached to the locknut 24. The ground cone 14 has a cylindrical body 18 with a plurality of threads 17 on the exterior surface, a flanged end 26, a plain end 16 and an axial bore 25 extending between the two ends 16, 26. The locknut 24 is substantially flat and ring-shaped with an outer circumferential edge 21, an inner circumferential edge 23, a first side 27 and a second side 29. The locknut 24 receives the plain end 16 and is moved over the cylindrical body 18 until the first side 27 of the locknut 24 abuts the back surface 20 of the flanged end 26 of the ground cone 14. The first side 27 of the locknut 24 is then attached to the back surface 20 of the flanged end 26 using fasteners, an adhesive, welding, or other means to form the ground cone/locknut assembly 12. The method used to attach the ground cone 14 to the locknut 24 depends on the materials that are used to fabricate the components. The second side 29 of the locknut 24 contacts the inside wall 50 of a flat surface when the fitting 10 is installed. Alternatively, the ground cone/locknut assembly 12 may be formed as a unitary structure. The flanged end 26 of the ground cone 14 has a plurality of apertures 22 that can be used to attach the locknut 24. The locknut 24 also serves as a stand-off to space the flanged end 26 of the ground cone 14 away from the surface of the wall 50. This creates a gap which is sealed by the collar 40 when the fitting 10 is installed in the wall 50 and tightened.

FIG. 3 shows the compression ring 30 component of the liquidtight fitting 10 with a first end 32 for receiving a liquidtight conduit 52 (FIG. 1), a smaller diameter second end 34 for receiving the plain end 16 of the ground cone 14 and an axial bore 35 extending between the two ends 32, 34. The exterior surface 36 of the compression ring extends radially outwardly between the first end 32 and the second end 34. The first end 32 is sized to compressively receive the liquidtight conduit 52. The second end 34 is sized to receive the ground cone/locknut assembly 12 and has a perimetrical lip 42 that extends radially outwardly from a point between a collar 40 and the second end 34 of the compression ring 30. The compression ring 30 has an O-ring 38 extending inwardly from the interior surface 37 that is located intermediate the two ends 32, 34. The step or stop 39 near the second end of the compression ring 30 limits how far the liquidtight conduit 52 can be inserted into the compression ring 30 before the ground cone/locknut assembly 12 is connected to the compression ring 30. When the ground cone/locknut assembly 12 is rotated, the conduit 52 is drawn towards the second end 32 of the ground cone 14. The collar 40 extends from the second end 34 and is flexibly attached thereto. When the ground cone/locknut assembly 12 is inserted into a liquidtight conduit 52 installed in the compression ring 30 and tightened, the collar 40 is drawn through the wall 50 and forms a seal around the inner circumferential edge 23 of the locknut 24. This also sealably compresses the perimetrical lip 42 against the exterior surface of the wall 50.

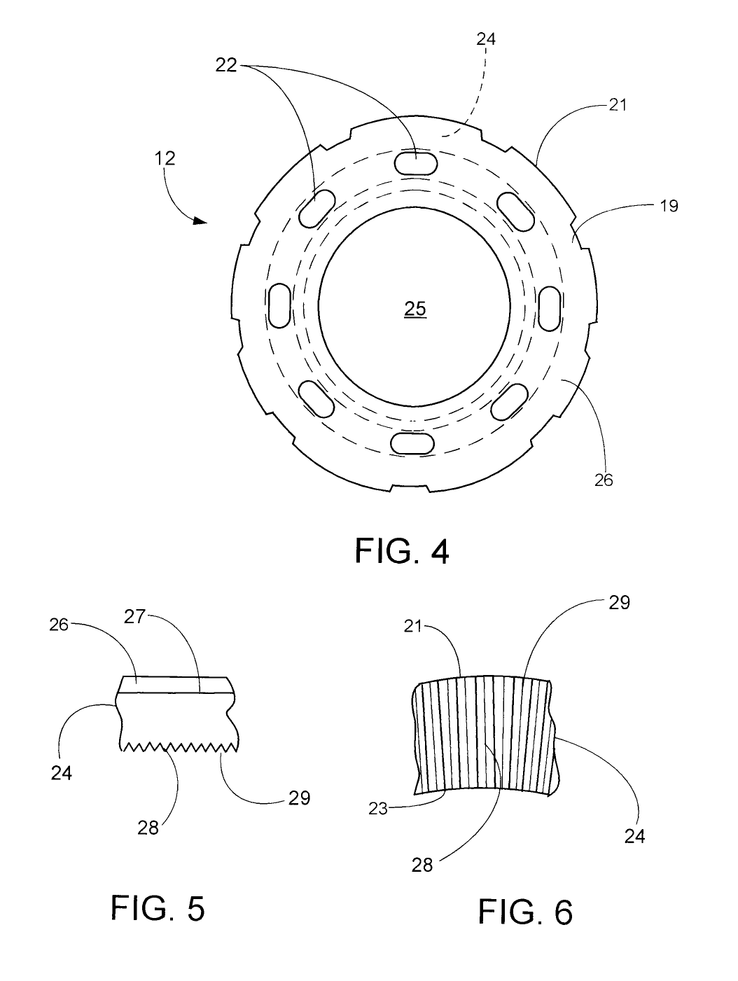

FIG. 4 shows an end view of the ground cone/locknut assembly 12 and the flanged end 26 of the ground cone 14. The flanged end 26 has a plurality of apertures 22 that are used to attach the ground cone 14 to the locknut 24. The axial bore 25 of the ground cone 14 extends through the center of the flanged end 26 and between the opposing ends 16, 26 of the ground cone 14. The locknut 24 can have a plurality of flats 19 on its outer circumferential edge 21 that can be engaged by a wrench for tightening the ground cone/locknut assembly 12.

FIG. 5 is a sectional, side view of the locknut 24 shown in FIG. 2. The second side 29 of the locknut 24 opposite the flanged end 26 of the ground cone 14 has a plurality of grooves 28 which are used to grip the surface of the wall 50 (FIG. 1). FIG. 6 is a view of the second side 29 of the locknut 24 shown in FIG. 2 between the first and second circumferential edges 21, 23. FIG. 6 shows the grooves 28 in the second side 29 of the locknut 24 extending between the first and second circumferential edges 21, 23 of the locknut 24.

Thus, while there have been described the preferred embodiments of the present invention, those skilled in the art will realize that other embodiments can be made without departing from the spirit of the invention, and it is intended to include all such further modifications and changes as come within the true scope of the claims set forth herein.

We claim:

1. A liquidtight fitting comprising:
a compression ring comprising:
a tubular body having an interior surface, an exterior surface, an inner diameter, a first end and a second end, wherein the first end is adapted to receive a liquidtight conduit having an interior surface;
a perimetrical lip extending radially from the exterior surface near the second end;
a collar extending from the second end; and
a stop, wherein the stop is adapted to prevent the conduit from passing through the second end of the tubular body;
a ground cone comprising:
a cylindrical body having an axial bore, an inner surface, an outer surface, an outer diameter and a plurality of threads on the outer surface, wherein the threads are adapted to engage the interior surface of the liquidtight conduit;
a plain end adapted for insertion into the second end of the compression ring; and
a flanged end having a back flange surface; and
a locknut comprising a substantially flat ring shaped body having a first side, a second side, an inner diameter and an outer diameter, wherein the first side of the locknut is attached to the back flange surface of the ground cone,
wherein the liquidtight conduit is inserted into the first end of the compression ring, wherein the plain end of the ground cone is inserted into an opening in a flat surface and then into the second end of the compression ring, and wherein the threads on the outer surface of the ground cone are adapted to engage the interior surface of the liquidtight conduit when the ground cone and the locknut are rotated.

2. The liquidtight fitting according to claim 1, wherein the inner diameter of the locknut is greater than the outer diameter of the cylindrical body of the ground cone.

3. The liquidtight fitting according to claim 1, wherein the collar has an inner diameter, and wherein the inner diameter of the collar is less than the inner diameter of the tubular body of the compression ring.

4. The liquidtight fitting according to claim 1, wherein the compression ring further comprises an O-ring extending radially inwardly from the interior surface and intermediate the first and second ends of the tubular body.

5. The liquidtight fitting according to claim 1, wherein ring-shaped body of the locknut has an outer circumferential edge, and wherein the outer circumferential edge has a plurality of flat surfaces that are adapted for engagement by a wrench.

6. The liquidtight fitting according to claim 1, wherein the ring shaped body of the locknut has an inner circumferential edge and an outer circumferential edge, and wherein the second side of the locknut has a plurality of grooves extending between the inner and outer circumferential edges.

7. The liquidtight fitting according to claim 1, wherein the locknut has an inner circumferential edge, wherein the inner circumferential edge is tapered so that the diameter of inner circumferential edge on the first side is less than the diameter of the inner circumferential edge on the second side.

8. The liquidtight fitting according to claim 7, wherein the collar is ring-shaped and has a distal circumferential edge, wherein the inner circumferential edge of the locknut is adapted to sealably receive the distal circumferential edge when the ground cone and the locknut are rotated and engage the interior surface of the liquidtight conduit.

9. The liquidtight fitting according to claim 1, wherein the perimetrical lip is adapted to sealably contact the flat surface when the ground cone and the locknut are rotated.

10. The liquidtight fitting according to claim 1, wherein the ground cone and the locknut are a unitary structure.

11. The liquidtight fitting according to claim 1, wherein the threads on the outer surface of the ground cone are adapted to move the liquidtight conduit towards the flanged end of the ground cone when the ground cone and the locknut are rotated.

12. The liquidtight fitting according to claim 1, wherein the compression ring is made from an elastomeric material.

13. The liquidtight fitting according to claim 1, wherein the compression ring is made from a semi-rigid material.

14. A liquidtight fitting comprising:
a compression ring comprising:
a tubular body having an interior surface, an exterior surface, an inner diameter, a first end and a second end, wherein the first end is adapted to receive a liquidtight conduit having an interior surface;
a perimetrical lip extending radially from the exterior surface near the second end;
a collar extending from the second end of the body, wherein the collar is ring-shaped and has a distal circumferential edge;
a stop, wherein the stop is adapted to prevent the conduit from passing through the second end of the tubular body; and
an O-ring extending radially inwardly from the interior surface and intermediate the first and second ends of the tubular body;
a ground cone comprising:
a cylindrical body having an axial bore, an inner surface, an outer surface, an outer diameter and a plurality of threads on the outer surface, wherein the threads are adapted to engage the interior surface of the liquidtight conduit;
a plain end adapted for insertion into the second end of the compression ring; and
a flanged end having a back flange surface; and
a locknut comprising:
a substantially flat ring shaped body having a first side a second side, an inner diameter and an outer diameter, wherein the first side of the locknut is attached to the back flange surface of the ground con; and
an inner circumferential edge, wherein the inner circumferential edge is tapered so that the diameter of inner circumferential edge on the first side is less than the diameter of the inner circumferential edge on the second side, wherein the inner circumferential edge of the locknut is adapted to sealably receive the distal circumferential edge of the collar,
wherein the liquidtight conduit is inserted into the first end of the compression ring, wherein the plain end of the ground cone is inserted into an opening in a flat surface and then into the second end of the compression ring, and wherein the threads on the outer surface of the ground cone are adapted to engage the interior surface of the liquidtight conduit when the ground cone and the locknut are rotated.

15. The liquidtight fitting according to claim 14, wherein the compression ring is made from an elastomeric material.

16. The liquidtight fitting according to claim 14, wherein the collar has an inner diameter, and wherein the inner diameter of the collar is less than the inner diameter of the tubular body of the compression ring.

17. The liquidtight fitting according to claim 14, wherein the compression ring further comprises an O-ring extending radially inwardly from the interior surface and intermediate the first and second ends of the tubular body.

18. The liquidtight fitting according to claim 14, wherein the perimetrical lip is adapted to sealably contact the flat surface when the ground cone and the locknut are rotated.

19. A liquidtight fitting comprising:
a compression ring comprising:
a tubular body having an interior surface, an exterior surface, an inner diameter, a first end and a second end, wherein the first end is adapted to receive a liquidtight conduit having an interior surface;
a perimetrical lip extending radially from the exterior surface near the second end;
a collar extending from the second end of the body, wherein the collar is ring-shaped and has a distal circumferential edge and wherein the collar has an inner diameter that is less than the inner diameter of the tubular body of the compression ring; and
an O-ring extending radially inwardly from the interior surface and intermediate the first and second ends of the tubular body;
a ground cone comprising:
a cylindrical body having an axial bore, an inner surface, an outer surface, an outer diameter and a plurality of threads on the outer surface, wherein the threads are adapted to engage the interior surface of the liquidtight conduit;
a plain end adapted for insertion into the second end of the compression ring; and
a flanged end having a back flange surface; and
a locknut comprising:
a substantially flat ring shaped body having a first side a second side, an inner diameter and an outer diameter, wherein the first side of the locknut is attached to the back flange surface of the ground con; and
an inner circumferential edge, wherein the inner circumferential edge is tapered so that the diameter of inner circumferential edge on the first side is less than the diameter of the inner circumferential edge on the second side, wherein the inner circumferential edge of the locknut is adapted to sealably receive the distal circumferential edge of the collar,
wherein the ground cone and the locknut are a unitary structure, wherein the liquidtight conduit is inserted into the first end of the compression ring, wherein the plain end of the ground cone is inserted into an opening in a flat surface and then into the second end of the compression ring, and wherein the threads on the outer surface of the ground cone are adapted to engage the interior surface of the liquidtight conduit when the ground cone and the locknut are rotated.

20. The liquidtight fitting according to claim 19, wherein the compression ring is made from an elastomeric material.
